(19) United States
(12) Patent Application Publication
(10) Pub. No.: US 2006/0268764 A1
(43) Pub. Date: Nov. 30, 2006

(54) Method, apparatus and system for use in allocating reverse channel resources

(76) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/138,050

(22) Filed: May 26, 2005

(51) Int. Cl. H04Q 7/00

(52) U.S. Cl. 370/328

(57) ABSTRACT

The present embodiments provide methods and systems for use in controlling and/or optimizing resource usage of reverse channel (142) wireless communications. Some embodiments determine a starting time (1014) of an access channel slot (628) of a reverse channel. Prior to the starting time of the slot, resource usage is reduced (1024) for reverse channel resources by at least one of a plurality of communications over the reverse channel. Upon detecting an absence (1030) of an access channel communication the resource usage of at least one of the plurality of communications over the reverse channel are increased (1034). Some methods provide for the transmitting of non-access channel communications over a reverse channel and determine an offset threshold (1222) defined by a time duration (632, 648) prior to a starting time of an access channel slot. Upon detecting an occurrence of the offset threshold, transmission resource usage of the non-access channel communication is reduced (1228).

### FIELD OF THE INVENTION

The present invention relates generally to wireless channel resource allocation, and more particularly to reverse channel resource allocation.

### BACKGROUND OF THE INVENTION

The use of wireless communication is dramatically and continually increasing. The amount of available bandwidth and/or communication channel resources being used is increasing. As this usage continues to increase one may expect the quality of service to begin to decrease due to dropped communications, interference from other communication devices and/or other signals, and other adverse affects.

Many wireless systems utilize a dual communication channel configuration, where some communications from a base station are carried on one channel while some communications from a mobile station are carried on a second channel. The resources for both of these channels can become over utilized. As such, the signal quality on communications in both directions can be adversely affected.

Different communication systems and/or protocols have attempted to optimize the use of these channels to improve signal quality and reliability. The resource usage of these channels has further attempted to be optimized in order to increase the number of communications that can be carried over these channels. Current communication systems, however, often still cannot meet system resource demands to satisfy the needs of the users.

### BRIEF DESCRIPTION OF THE DRAWINGS

FIG. 1 depicts a simplified block diagram of a wireless communication system according to some present embodiments;

FIG. 2 depicts a simplified block diagram of a base station according to some implementations of the present embodiments that can be utilized in the system of FIG. 1;

FIG. 3 depicts a simplified block diagram of a wireless mobile station according to some embodiments that can be utilized in the system of FIG. 1;

FIG. 4 depicts a simplified graphical representation of a resource capacity of a reverse channel;

FIG. 5 depicts a simplified graphical representation of a reverse channel capacity similar to that of FIG. 4;

FIG. 6 depicts a graphical representation of the communication capacity of a reverse channel according to some present embodiments;

FIGS. 7-9 depicts graphical representations of the communication capacity of a reverse channel similar to that of FIG. 6;

FIG. 10 depicts an embodiment of a process for allocating resources for communications over a reverse channel;

FIG. 11 depicts one example of a process for use in monitoring and adjusting resource usage; and

FIG. 12 depicts a simplified flow diagram of a process for use in reallocating reverse channel resources of one or more transmitting devices transmitting non-access channel communication(s) over the reverse channel.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

The present embodiments provide methods and systems for use in controlling and optimizing resources for reverse channel or link wireless communications. Many wireless communication systems distinguish between communications from a base station to a mobile station (typically referred to as a forward link or forward channel communication) and communications from a mobile station to a base station (typically referred to as a reverse link or reverse channel communication). These forward and reverse channel communications are distinguished through various means, such as different frequency bands and other such distinctions. For example, some wireless communication protocols, such as code division multiple access (CDMA) systems, utilize at least a portion of the resources and/or capacity of the reverse channel for certain communications, such as originations, responses to pages, registrations, short messages, such as Medium Access Control (MAC) messages, some data packets, and other such communications. In some communication systems these communications are communicated over a portion of the reverse channel commonly referred to as an access channel (e.g., access channel communications (ACH) and/or enhanced access channel communication (EACH)) or slotted contention channel. It is noted that the present embodiments are described below with reference to communications over an access channel of a reverse link. The present embodiments, however, can be equally applied to other communication systems and/or protocols that define certain portions of a communication channel for selected types of communications. For example, the present embodiments can be utilized in systems employing evolution-data-voice (EV-DV), evolution data only (EV-DO), evolution data only, Revision A (EV-DO-A), universal mobile telecommunications system (UMTS), CDMA2000, wideband CDMA (WCDMA), wireless local area network (WLAN) protocols, and other protocols and/or technologies.

Access channel communications often have different resource requirements than other non-access channel communications communicated over a reverse channel as fully described below. In many instances, these access channel communications utilize greater resources than other types of non-access channel communications. As a result, the present embodiments attempt to optimize the distribution of resources for both access channel and non-access channel communications, while reducing amounts of wasted resources.

In some implementations of the present embodiments, resource usage is controlled at least in part by attempting to anticipate access channel communications. For example, some embodiments determine a starting time of an access channel slot of a reverse channel during which an access channel communications can occur as further described below. Prior to the starting time of the access channel slot, resource usage is reduced for reverse channel resources by at least one of a plurality of communications over the reverse channel. Upon detecting an absence of an access channel communication the resource usage of at least one of the plurality of communications over the reverse channel is increased. Some methods of present embodiments additionally and/or alternatively provide for the transmitting of non-access channel communications over a reverse channel and determine an offset threshold defined by a time duration prior to a starting time of an access channel slot. Upon detecting an occurrence of the offset threshold, transmission resource usage of the non-access channel communication is reduced.

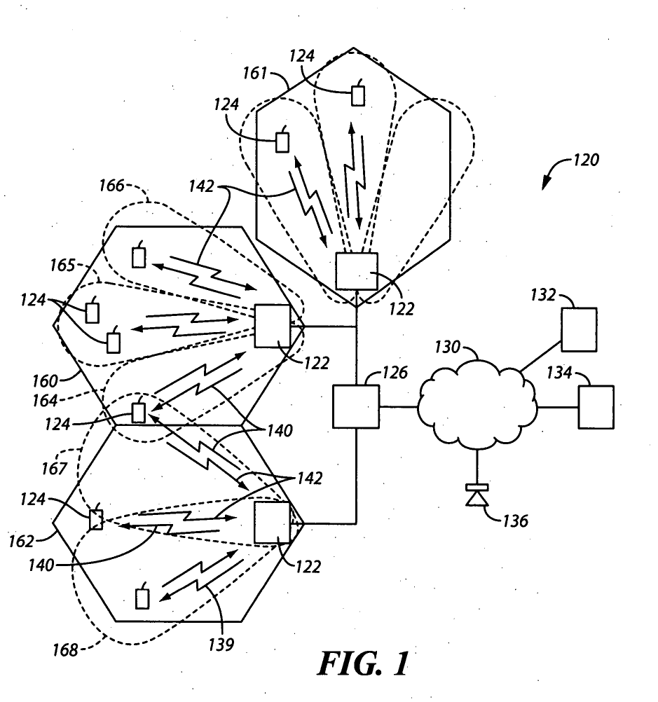

The implementation of resource usage control and/or optimization is implemented, at least in part, through wireless communication devices, commonly referred to as mobile stations. In some embodiments, mobile stations include a transmitter configured to wirelessly transmit over a reverse channel, a reverse channel resource usage controller coupled with the transmitter that provides at least some control over an amount of reverse channel resources utilized by the transmitter, and a controller that is coupled with the transmitter and the resource usage controller. The controller is configured to determine a start time for an access channel slot and an offset threshold prior to the start time. In response to the determined offset threshold, the controller directs the resource usage controller to control the transmitter to decrease reverse channel resources utilized by a non-access channel transmission. FIG. 1 depicts a simplified block diagram of a wireless communication system 120. The system includes one or more base stations 122 where each is capable of wirelessly communicating with one or more mobile stations 124. In some embodiments, the system further includes a central controller 126, such as a mobile switching center (MSC) and/or base station controllers, a distributed network 130, such as a public switched telephone network (PSTN), integrated services digital network (ISDN), an extranet such as the Internet, an intranet, or other such networks. One or more other devices and/or systems can further couple with the distributed network, such as remote servers 132, databases 134, communication devices 136 (e.g., wired telephones), other wireless communication networks, and other devices or systems. The wireless communication from base station to mobile is typically conducted over a first channel, commonly referred to as a forward channel 140, and some communication from mobile to base station is conducted over a second channel, commonly referred to as a reverse channel 142.

In some implementations, one or more base stations 122 establish wireless communication with mobile stations 124 within a given geographic area, often referred to as a cell 160-162. Additionally, each base station produces one or more antenna signals, which in some implementations are configured to cover sub-areas of the cell 160, and are sometimes referred to as sectors 164-168, where typically a base station 122 may communicate with one or more mobile stations 124 in a cell 160. A mobile station 124 can communicate with a base station 122 from a first cell 160 and a sector 164, and may transition to a neighboring cell 162 and sector 167 depending on the mobility and signal quality of the mobile station 124.

Further, each mobile station 124 typically can at times simultaneously communicate with a plurality of base stations 122. Communicating with a plurality of base stations allows the system to take advantage of handoffs (e.g., soft handoffs) between base stations 122 to optimize the wireless signal quality. Therefore, a mobile station 124 that is communicating over a first cell 160 and sector 164 controlled by a first base station 122 may be handed off to a neighboring sector 165 within the same cell, or a neighboring sector 167 within a neighboring cell 162 controlled by either the same base station 122 or a second base station.

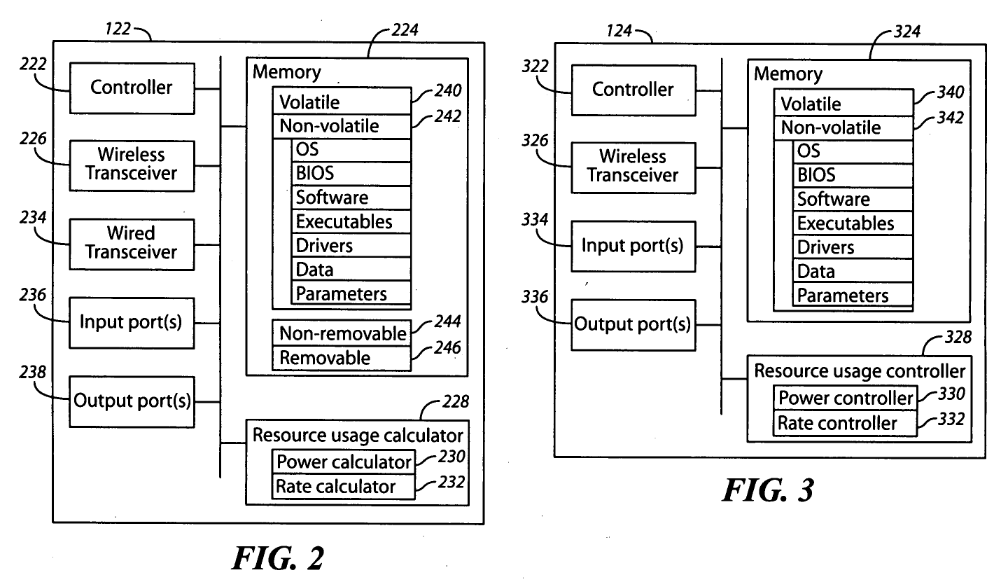

FIG. 2 depicts a simplified block diagram of a base station 122 according to some implementations that can be utilized in the system 120 of FIG. 1. The base station includes one or more controllers 222, memory and/or computer readable medium 224, one or more wireless transceivers 226 (i.e., wireless transmitter(s) and receiver(s)), and one or more resource usage calculators 228 that cooperates with the controller to determine amounts of channel resource usage, such as reverse channel resource usage. The one or more resource usage calculators can include a power level calculator 230 that determines power levels at which communications are being transmitted from remote mobile stations 124, and a transmission rate calculator 232 that determines the transmission bit rates that mobile stations are utilizing in their communications. The resource usage calculator can be implemented as a separate component of the base station, as part of the controller 222, or can be implemented through firmware and/or software that is utilized by the controller and other such implementations. The base station 122 can further include, in some embodiments, one or more wired transceivers 234, input device ports 236 that couple with one or more input devices, such as keyboards, remote controls, mouse, control buttons, and other similar input devices, and/or output ports 238 can further be included to drive output devices, such as a display, printer, and other such output devices.

The memory 224 can be implemented through volatile memory 240 (e.g., RAM), non-volatile memory 242 (e.g., ROM, flash memory, and other such non-volatile memory) and/or a combination of volatile and non-volatile memory. The non-volatile memory can store one or more operating sources, basic input-output system code (BIOS), software, executables, drivers (e.g., communication drivers, filter driver, and other such drivers), data, control parameters, and the like for implementing the present embodiments. In some embodiments, the memory 224 further includes additional non-removable memory 244 and/or removable memory 246, such as magnetic disk drive, optical disk drive, and other relevant memory devices. Further, the base station 122, in some implementations, further accesses remote memory, such as remote databases 134 and/or other memory.

FIG. 3 depicts a simplified block diagram of a wireless mobile station 124 according to some embodiments. The mobile station can include one or more controllers 322, memory and/or computer readable medium 324, one or more wireless transceivers 326, and one or more resource usage controllers 328 that include, for example, a power controller 330 and a transmission rate controller 332 that control the resource utilized by the wireless transceiver(s) 326 in transmitting reverse link communications based on instructions from the controller 322. The resource usage calculator can be implemented as a separate component of the mobile station, as part of the controller 322, or can be implemented through firmware and/or software that is utilized by the controller, and other such implementations.

In some embodiments, the mobile station 124 further includes one or more input device ports 334 that can couple with one or more input devices, such as microphone, keyboards, selectable buttons, and other similar input devices, and/or output ports 336 can further be included to drive output devices, such as a headphone, display 338, and other such output devices. The memory 324 can be non-removable and/or removable, and implemented through volatile memory 340 (e.g., RAM), non-volatile memory 342 (e.g., ROM, flash memory, and other such non-volatile memory) and/or a combination of volatile and non-volatile memory for storing one or more operating sources, basic input-output system code (BIOS), software, executables, drivers, data, control parameters, and the like for implementing the present embodiments.

Referring back to FIG. 1, the base stations 122 wirelessly communicate with the mobile stations 124 over forward and reverse wireless communication links or channels 140, 142, respectively. The reverse channel 142, as introduced above, can provide communications such as originations, responses to pages, registrations, short messages, such as MAC messages, some data packets, control communications, and other such communications. In some implementations, the reverse channels are further utilized for dedicated channel communications, where resources of the reverse channel are dedicated to a specific mobile station to optimize communication from that mobile to the base station (which in some instances forwards the communication to the MSC to be distributed to another base station, other devices, and/or networks.) The dedicated communications can communicate data, audio, visual, control and other such data.

Access channel communications provide communication over the reverse link to initiate wireless communications from a mobile station for control parameters, responses and other messaging and communications as described above and below. In some wireless communication protocols, these access channel communications utilize greater reverse channel resources because of the way these communications are performed and the standards to be satisfied. For example, some access channel communications do not take advantage of soft handoffs, the power levels of access channels may not be adjusted or adjusted at relatively slow rates, do not provide for partial retransmission of the communication (e.g., do not take advantage of hybrid automatic-repeat-request (HARQ)) and instead have to have the entire communication repeated when errors are detected, and other such factors as are further described below. As such, some systems transmit access channel communications utilizing greater resources than other non-access channel communications (e.g., dedicated reverse channel communications).

The present embodiments attempt to optimize the use of resources of the reverse channel to at least in part optimize the amount of resources made available for non-access reverse channel communications while still attempting to ensure accurate communication over the access channel of the reverse channel. The communications over the access channel to a base station can be critical as these communications can initiate further communications from a mobile as well as include responses to inquiries (e.g., in-coming calls or data) from the base station 122 or other device(s) (e.g., MSC 126, other wireless devices, other communication devices, and the like).

Typically, a reverse channel has a fixed amount of available resources or communication capacity. Because of these limited resources, the number, types and/or amount of communications utilizing a reverse channel are limited. As introduced above, the communications carried over the access channel are typically relatively important and as such, can be defined with higher priority over at least some of the other reverse channel communications, such as dedicated reverse channel communications. Therefore, some present embodiments monitor the resource usage of the reverse channel 142 in attempts to ensure access channel communications are accurately received while attempting to maximize the resources available for other reverse channel communications.

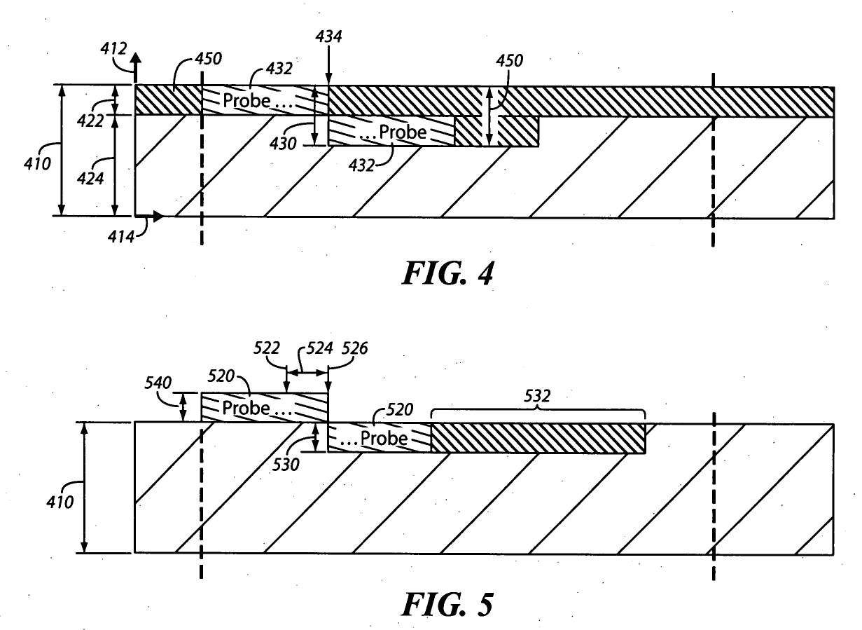

FIG. 4 depicts a simplified graphical representation of a total resource capacity 410 of a reverse channel with capacity defined along a vertical axis 412 and time defined along the horizontal axis 414. The resource capacity can be utilized and/or allocated to different types of communication, such as access channel communications, dedicated reverse link communications and other such reverse link communications. Some systems define a certain amount of capacity 422 that is continually reserved for access channel communications. These systems attempt to continue to maintain the reserved amount of access channel capacity 422 to ensure accurate reception of the access channel communication. The remainder of the reverse link capacity 424 is allocated as needed to other reverse link communications, such as dedicated channel communications.

To continue to maintain the reserved amount of access channel capacity 422, these systems typically increase the amount of resources 430 allocated for access channel communications when one or more access channel communications are detected (e.g., an access channel probe 432 is detected 434). By maintaining the reserved amount of resources 422, the system attempts to ensure that resources are available to accurately receive the access channel communications.

In maintaining the reserved amount of access channel capacity 422, the system wastes a large amount of resources 450. As is known in the art, the access channel is typically lightly utilized. For example, it is common for 90% or more of access channel resources to be unused and thus wasted. According to communication standards as are known in the art, systems typically allocate resources in a predefined manner that accommodates the duration or length of a predefined longest access channel communication to be received. Therefore, given that typical access channel communications are relatively short in length and some systems reserve resources 422 for a predefined longest access channel communication, further resources are wasted 450 when allocating for a much larger transmission than typically occurs.

FIG. 5 depicts a simplified graphical representation of a reverse channel capacity 410, similar to that of FIG. 4. Some systems, however, attempt to maximize the reverse channel capacity 410 for non-access channel communications, such as dedicated reverse link communications, by allowing the allocation of substantially all or all of the available resources 410 when needed. When a received access channel communication, such as an access probe 520, is detected 522, the system at that time initiates a reduction in resource allocation and designates resources 530 for the access probe. After a period of time 524 needed by the system to communicate the reallocation of resources and for the mobile stations to react to the instructions, the reallocation is implemented 526 providing a predefined and/or calculated amount of resources 530 for the access probe 520. In some instances, this amount of resources 530 allocated to the access probe 520 is defined by the length of the longest possible access channel communication as described above. Therefore, additional wasted resources 532 results due to the typical short length of access channel communications, which often does not need as much resources as allocated.

Further, because the system resources can be exceeded 540 when the access channel probe 520 is initially received, there is often a large amount of interference and low signal quality of the probe. This low signal quality can result in relatively large numbers of corrupted reverse channel communications such that the communications have to be retransmitted. As such, the amount of resources reallocated 530 and 532 is completely wasted as the access channel communication 520 has to be retransmitted.

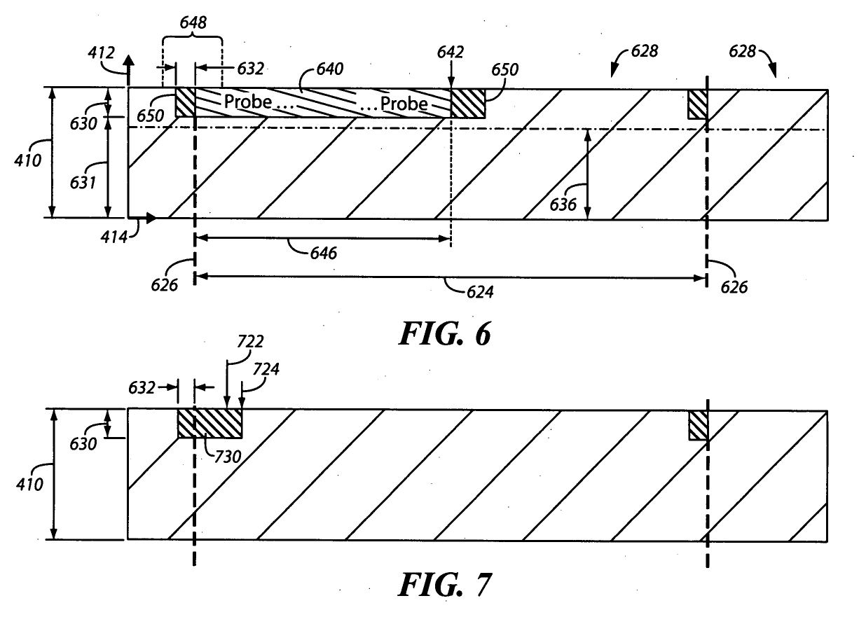

The present embodiments of the invention attempt to optimize the use of the reverse link capacity while still accurately receiving access channel communications. FIG. 6 depicts a graphical representation of the communication capacity 410 of a reverse channel according to some present embodiments with capacity defined along a vertical axis 412 and time defined along a horizontal axis 414. In some implementations, the access channel communications are often limited to start at predefined points in time, referred to as offsets, by dividing the access channel communication into slots of time 628. Typically, each slot has the same length 624 and is dictated by a longest predefined access channel communication. For example, if the longest possible access channel message that can be sent is about 100 ms (e.g., according to one or more wireless communication standards as are known in the art), the slots can be defined as about 100 ms periods of time (including accommodating, for example, overhead associated with access channel communications), with offsets 626 designating the beginning of each slot 628. Some access channel communications, however, can be longer than a single slot and potentially extend over multiple slots.

In utilizing the offsets 626, some implementations of the present embodiments of the invention anticipate the reception of an access channel communication and reduce the amount of allocated reverse channel resources 410 by a predefined amount 630 at or just prior to an offset 626. The period of time 632 before the offset where the resource allocation is reduced depends on the system, the speed at which resources can be freed up and other parameters and conditions. By reducing the resources at or just prior to the offset 626, the present embodiments significantly reduce wasted resources 650 relative to at least those systems that maintain a threshold 422 available. Resources are freed up, in some implementations, by reducing power levels at which one or more mobile stations 124 communicate non-access channel communications over the reverse channel (e.g., reducing power levels of dedicated reverse channel communications). Alternatively and/or additionally, the transmission rates (e.g., data bit rates) can be reduced for one or more non-access channel reverse link communications. The time 632 prior to the offset 626 at which resources are freed can depend on many factors, such as load, anticipated reception of access channel communication, time needed to implement the reallocation, and other similar factors. Therefore, the time 632 varies depending on the system and the response of the system and the mobile stations.

Referring to FIGS. 1 and 6, in some embodiments, the system 120 reduces the resource usage by an amount 630 on the reverse link through a base station 122 setting a reverse activity bit (RAB) to a predefined value (e.g., set to one (1)) and communicating that RAB to one or more mobile stations 124 actively communicating over the reverse channel (and/or potentially going to communicate over the reverse channel) instructing the one or more mobile stations 124 based on some probability, typically defined by the base station 122, that the one or more mobile stations 124 should decrease their data rate and/or transmit power of their non-access channel communications on the reverse channel by a predefined amount (e.g., by one (1) unit value). This defined probability can depend on the amount of activity occurring on the reverse channel, the need to reduce interference, and other such factors. For example, a base station can determine that the reverse channel resources should be decreased by an amount such that 20% of the mobile stations actively communicating non-access channel communications over the reverse channel should reduce their resource usage by one (1) unit. As such, the base station 122 can generate an RAB with a 20% probability instructing the currently active mobile stations communicating non-access channel communications over the reverse channel to reduce by one unit, resulting in approximately 20% of the mobile stations 124 on the reverse channel each decreasing their resource usage by one unit, effectively freeing up the desired amount of reverse channel resources 630. As introduced above, the reduction of resources can include mobile stations 124 reducing power, reducing data rates, other methods, and/or a combination of methods.

The system 120 typically evaluates the load and/or utilized capacity of the reverse channel prior to initiating a freeing up of resources. In evaluating the load of the reverse channel, the system determines whether the load exceeds a predefined level or load threshold 636. When the load does not exceed this predefined load threshold, the system typically does not reallocate resources because the probability that interference with an access channel communication will occur is low. In some implementations, the system not only evaluates a current sector 164, but also evaluates reverse channel communications on neighboring sectors 165 and/or cells 162 and determines the probability of interference with reverse access channel communications due to these communications occurring outside the present sector. 100391 In some wireless communication systems, the base station controls mobile stations' transmit power by issuing instructions (e.g., RAB or other instructions) to the mobile stations to adjust the levels of transmit power. These instructions can be communicated to the mobiles multiple times a second while the mobile station is transmitting, and often are periodically issued. Some systems employ base stations 122 that issue power adjustment instructions to one or more mobile stations 124 designating whether the mobile station(s) is to adjust transmit power up or down. For example, a power adjustment instruction can be dictated by a single bit where a value of one (1) defines an instruction to the mobile station to increase transmit power by a first fixed amount (e.g., increase by one unit), and a zero bit value defines an instruction to decrease transmit power by a second fixed amount (e.g., decrease by one unit).

In some present embodiments of the invention, one or more mobile stations can be configured to autonomously reduce resources utilized by non-access channel communications prior to an offset 626 without instructions from the base station or other devices of the system, and without knowledge of an access channel transmission either at the base station or at the mobile station. Additionally or alternatively, a mobile station may interpret a periodic power adjustment instruction received from a base station differently at or near an offset to implement, for example, a greater reduction of resource 630 usage just prior to or at 632 the beginning of an offset than a reduction due to an adjustment instruction received at other times during a slot 628. For example, a mobile station may detect and/or recognize that an access channel offset 626 is to begin within a defined time period, and interpret a power adjustment instruction received within a time threshold period 648 relative to the offset with the instruction bit set to a value of one that is received within the predefined period proximate the offset to increase the power level by an amount less than the typical one (1) unit (e.g., increase by 0.5 units (50%) or some other value depending on the system, the load and/or other factors), and/or further interpret an instruction bit set to zero to decrease the power level by an amount greater than the typical one unit (e.g., decrease by 1.5 units (150%) or some other value depending on the system, the load and/or other factors). Similar types of interpretations may be made for adjustments to data rates and other resources. The time threshold period in some implementations can be defined between a time prior to the offset 626 and the offset and/or extending into the slot 628.

The system may also be configured to send a message to the mobile station defining how to interpret resource adjustment instructions, or a message defining a quantity by which a mobile should reduce resources at an offset. Through this implementation, a base station 122 can utilize the knowledge that the mobile stations 124 will adjust resources differently within the period prior to the offset and free up the desired resources 630 at or just prior to the offset 626 without employing alternative and/or additional commands. Further, the system does not have to be changed as the implementation of the freeing up of resources occurs at the mobile stations.

Still referring to FIG. 6, following the reduction 632 of resources by an allocated capacity 630, the system determines whether one or more access channel communications (e.g., an access probe 640) are received, for example, at or following an offset 626. When one or more probes 640 are received, the system maintains a level of resources allocated to access channel communication(s) (e.g., 630) at sufficient levels attempting to accurately receive the one or more probes. As further described below, some embodiments adjust the resources allocated non-access channel communications 631 in further attempts to ensure accurate reception of the probe. For example, when signal quality of the access probe falls, the system may continue to reduce resource usage 631 by non-access channel communications to provide still further resources 630 for the access channel communication(s) and/or reduce interference on the access channel communication(s). This may include reducing resources to non-access channel communication in a neighboring sector 164-168 (see FIG. 1). For example, a base station 122 can communicate with a mobile switching center 126 or other controller that in turn instructs a base station controlling a neighboring sector and/or cell to reduce resources of communications in a given neighboring sector. Additionally and/or alternatively, the base stations 122 may be configured to have direct communication with one another, for example through hard wire connections and/or wireless connections, to submit requests and/or coordinate power adjustments on reverse channels. For example, a base station with the knowledge that the neighboring sector's offsets occur at different times than the present sector (i.e. more often, less often or with a delay), may additionally reduce resources in accordance with the neighboring sector's offsets.

Alternatively, when a probe 640 is not received or detected at the beginning of a slot 628, the system frees up the allocated resources 630 for use by other reverse channel communications. In some implementations, the system identifies that a probe or other access channel communication is not being received when a preamble to the probe is not detected, and the system at that time frees up the allocated resources for use by other reverse channel communications.

FIG. 7 depicts a graphical representation of the communication capacity 410 of a reverse channel similar to that of FIG. 6. As introduced above, as the system detects the approach of an offset 626, the system reduces resource usage by a predefined amount 630 over the reverse channel just prior to 632 the offset freeing up resources for the potential reception of one or more access channel communications. In some implementations, when the system does not detect an access channel communication following the offset, the system identifies 722 that an access channel is not being communicated and reallocates 724 those resources 630 that were previously freed up for potential access channel communications. This rapid detection of the absence of an access channel communication further reduces the amount of wasted resources 730 on the reverse channel.

Referring back to FIG. 6, in some implementations, the system further monitors the duration or length 646 of an access probe or other access channel communication and once the probe has been received, reallocates access channel resources 630 to further increase resources for other communications over the reverse channel. The monitoring of the probe can include detecting a final cyclic redundancy code (CRC) of the probe 640, which indicates to the system that the probe transmission is complete, detecting that an access channel signal is no longer being received, and other indications of the termination of the probe. Once it is determined that the probe or other access channel communication is absent 642 (e.g., has terminated, an error was detected, the signal quality dropped below a threshold, and other such determinations of the absence of the access channel communication), a reallocation of resources can occur. Additionally or alternatively, in some implementations, the access channel communication can include a header with a duration or length parameter that defines and/or can be used to determine a length 646 of the probe. Based on the defined length 646 of the probe, whether defined to end within a single slot or extend into a plurality of slots, the system determines when an end of the probe 642 is to occur and frees up the allocated resources for use by other reverse channel communications at the end of the probe. Therefore, the present embodiments provide a relatively large reduction in wasted resources 650 over other systems.

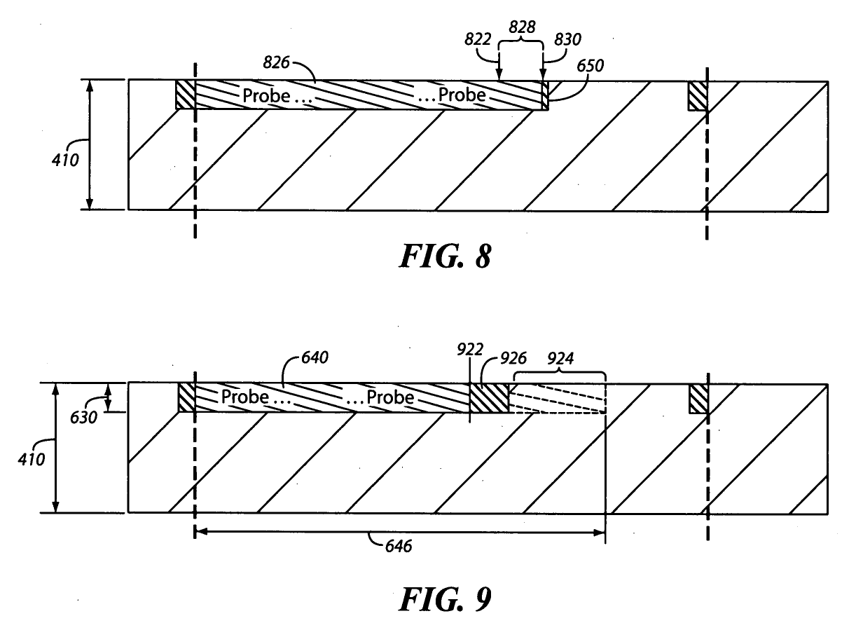

FIG. 8 depicts a simplified graphical representation of a reverse channel capacity 410, similar to that of FIG. 6, illustrating an additional and/or alternative method for reducing wasted channel resources. In some embodiments, the system further reduces the wasted resources (e.g., resources 650) associated with the time needed for the system to react to a determination that resources allocated for an access channel communication are available and can be reallocated, the time to sending an instruction to one or more mobile stations to reallocate resources (e.g., increase transmit power and/or increase data rates), and the time for the mobile stations to implement the reallocation of the available resources 650. These embodiments are configured to calculate an end of probe threshold 822 by using a defined length of the probe 826 (e.g., as defined in a header of the probe) and an anticipated amount of time 828 needed to initiate the reallocation and the implementation at the mobile stations of that reallocation. The end of probe threshold 822 is a time prior to the end 830 of the probe 826 such that an initiation by the system to reallocate resources is fully effectuated at a time corresponding to, near, at, or shortly following the probe termination 830. By anticipating the end of the access channel communication, the system can further reduce the wasted resources 650 associated with the amount of time needed to reallocate the resources and initiate that reallocation through the mobile devices 124 by initiating the reallocation prior to the termination 830 of the probe so that resources are reallocated proximate the end 830 of the probe. In some implementations, the reallocation is initiated prior to the termination of the probe such that the resource allocation is ramped up prior to the termination of the probe.

FIG. 9 depicts a simplified graphical representation of a reverse channel capacity 410, similar to that of FIG. 6. Some present embodiments further attempt to optimize the use of reverse channel resources and reduce wasted or unused resources by, in part, tracking the quality of the received probe 640 and detecting when an error has occurred that would require the retransmission of the probe. Additionally or alternatively, some embodiments further optimize the resource allocation by detecting when an access channel communication is corrupted 922. When an access channel communication is corrupted, these systems can stop attempting to receive the communication, and free up at least part of the previously allocated resource 630 for the access channel communication to be available for other reverse channel communications. The detection of a corrupted access channel communication can be achieved by utilizing CRCs, signal to noise ratios, symbol error rate, receive power levels, and other such detections.

Some access channel communications are divided into multiple frames, where one or more frames use CRCs to verify the communication as it is received. When a CRC failure is detected 922 during a communication, the system stops attempting to accurately receive the communication 640 and frees up resources 924 for the remainder of the probe duration 646 that would otherwise be wasted due to the fact that the communication typically has to be retransmitted. Some waste of resources 926 typically occurs due to the time needed to initiate and implement the reallocation. Similarly, some implementations monitor the signal quality, and when signal quality of the access channel communication falls below a predefined level the system designates the communication as failed 922 and initiates the redistribution of resources.

A further reduction in wasted capacity is accomplished in some embodiments by reducing the number of access channel offsets (i.e., increasing slot duration) during periods of time where the usage capacity of the reverse channel has at least a predefined relationship with respect to a usage threshold or thresholds such that the number of access channel offsets can be reduced when the communication load on the reverse channel is high relative to the number of offsets during periods of time where communication loads over the reverse channel are low (e.g., off-peak hours). As such, the duration of slots during relatively heavy loads is increased relative to the duration of slots during periods of lighter loads. The increased number of offsets during relatively light loads provides for a more rapid response time during those periods with low load. This increase in the number of offsets is generally achieved without increasing the amount of wasted resources (e.g., resources 630 of FIG. 7) because the system typically detects that the load threshold 636 is rarely exceeded and thus avoids necessitating a reduction in resources. Further, the increased number of offsets allows, in some implementations, for more access channel communications to occur in the same amount of time. Additionally, the increase in the number of offsets can potentially also reduce the load on the reverse channel because there is less likely to be multiple access channel communications occurring during a single slot, where access channel communications typically utilize larger amounts of capacity than other non-access channel communications as further described below.

During high load periods of time, the system often detects that the load exceeds the load threshold, thus causing an initiation 632 of a reduction in resources in anticipation of the offset 626. Due to the relatively small number of slots that actually contain access channel communications, this anticipated reduction in resources (e.g., see FIG. 7) results in wasted capacity 730, and can potentially result in accumulated wasted resources over time. Those implementations of the present embodiment, however, that provide for the reduction in the number of offsets during periods of high load allow the system to decrease the number of times the system reduces resources 632 of non-access channel communications in anticipation of the offset (e.g., reducing resources 630 of FIG. 7). Therefore, the system provides an additional accumulated decrease of the wasted resources over time.

For example, an access channel may typically have 10 different slot offsets every second. Other implementations may typically employ more or less than 10 slots per second, and the present embodiments are not limited to a specific number of slots per second. When the load on the reverse channel exceeds the load threshold, the system then reduces resources on the reverse channel 10 times a second, one in anticipation of each slot.

During periods of time of high load, some present embodiments beneficially reduce the number of slot offsets per second (e.g., reduce from 10 to 5 per second), such that the system is reducing resources 632 at the offsets five times in a second instead of 10 times a second. Because access channel communications are communicated relatively infrequently (e.g., only in about 10% of offsets), the decrease in the number of offsets at high loads reduces the number of times a second the system reduces resources 632 in anticipation of the offset, therefore reducing the amount of wasted capacity 730 due to the low percentage of access channel communications occurring. Some embodiments further increase a number of access channel communication detectors (e.g., wireless modems and/or transceivers in the base station 122) to provide additional capacity for receiving access channel communications during the reduced numbers of offsets. In these implementations, even though there are reduced numbers of times when mobile stations can start transmitting access channel communications, the system employs, for example, multiple different channels, scrambling codes, and/or Walsh codes that mobile stations can use on the reverse channel. The mobile stations can, for example, randomly select a scrambling code that is used by one modem and send an access channel communication at a particular offset with the chosen scrambling code. The next time the mobile station sends an access channel communication, the mobile station selects an alternate scrambling code. The access channel communication detectors can further be activated at staggered intervals to further provide desired communication capacity. For example, if there are 10 modems staggered such that one is starting every 50 ms, or two are starting every 100 ms, the same number of access channel messages can be communicated as though 10-20 offsets existed. In these implementations where the number of offsets is reduced during high load periods of time, the delay in response time is sacrificed in exchange for reduced wasted capacity (e.g., 730, see FIG. 7), but a benefit is that during the period of time of high load, there is less wasted capacity, generally higher signal quality, and a potential increase in user satisfaction. It is noted that multiple different slot durations can be employed depending on the load of the reverse channel and/or other factors. For example, slot duration can have a first length at high loads, a second length that is shorter than the first length during medium loads, and a third length that is shorter than the second length during light loads.

In some implementations of the present embodiments, a combination of resource adjustments can be employed to achieve the desired allocation of resources 630 at the offset 626 and/or during the slot. For example, referring back to FIG. 6, the system can initiate 632 a reduction in usage of reverse channel resources 630 at the offset by instructing one or more mobile stations to reduce transmit power. The use of power adjustments provides for relatively rapid implementation of the reduction in resources, thus, allowing the system to minimize the period 632 prior to the offset 626 when the reduction is initiated. Following the offset, the system then attempts to determine the presence or absence of an access channel communication. In those situations where an access channel communication is not detected, the system can quickly instruct the one or more mobile stations to readjust the power levels allowing the mobile stations to take advantage of the available resources. This power adjustment again takes advantage of the relatively rapid response time associated with power adjustments.

In the event where an access channel is detected following the power adjustments implemented by the mobile stations, the system can then instruct the mobile stations to reduce transmission data rates to free resources. In some systems, reducing transmission data rates provides a better reduction in noise and/or interference of access channel communications than achieved by power reduction. The implementation of adjusting data rates, however, can take longer to implement than power adjustments in some systems. Therefore, by initially implementing power adjustments and then employing data rate adjustments the system provides improved response time for those instances where access channel communications are not received while still employing data rate adjustments to additionally or alternatively reduce interference and/or noise. In some implementations, depending on load and/or signal quality, while the system reduces data rates, the system can further instruct the mobile stations to increase power levels, as the reduced data rates are freeing up additional resources. Other combinations of resource reductions can be employed, such as initiating the reduction 632 through reduced data rates, then using power adjustments while a probe is detected to provide rapid adjustments.

The amount of resources 630 that are freed up for access channel communications varies depending on the system employing the present embodiments, the load of the system, the expected access channel usage, and/or other such factors. In some wireless communication systems and/or protocols, as are known in the art, the amount of reverse channel capacity that should to be reserved for access channel communications is greater than other reverse channel communications, such as dedicated reverse channel communication. Some of the reasons for this are because an entire access channel communication often has to be retransmitted if an error in one of the frames of the multi-frame communication is detected; access channel communications typically do not employ or get the benefit of soft handoff; and that access channel communications often do not provide for rapid (or in some instances any) adjustment to transmit power as is provided in other non-access channel communications, such as dedicated reverse channel communications. Therefore, access channel communications are typically overpowered in some implementations as compared with other non-access channel communications to further improve reception quality.

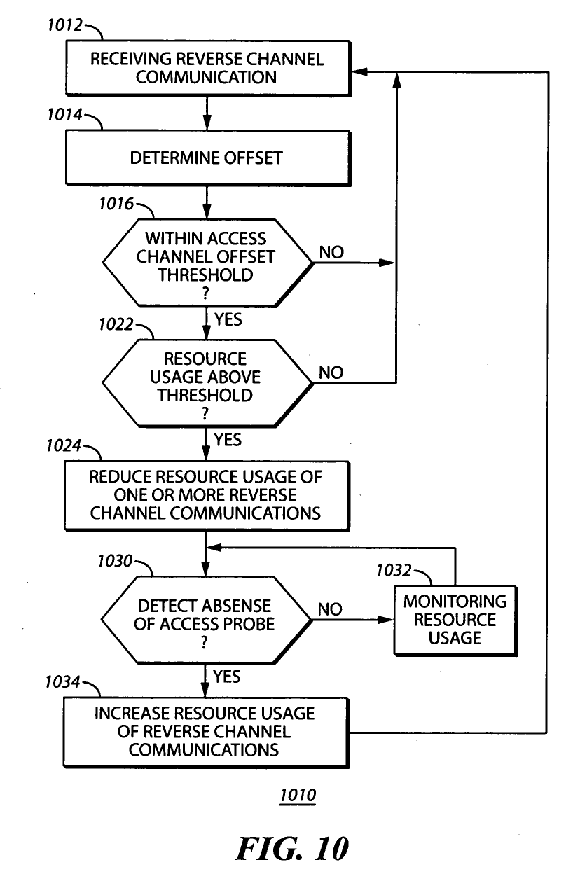

FIG. 10 depicts an embodiment of a process 1010 for allocating resources for communications over a reverse channel. This process, at least in part, optimizes the reverse channel resources while providing sufficient resources in attempts to accurately receive one or more access channel communications (e.g. access probes over the access channel). An example of implementing this process 1010 is a base station 122 allocating resources to one or more mobile stations 124. In step 1012, one or more communications are detected and/or received at a base station over the reverse channel. The reverse channel communications are typically comprised of non-access channel (e.g. dedicated channel) and/or access channel communications. In some embodiments, the communications over the access channel are configured to occur within access channel slots 628. The beginning of an access channel slot is referred to as an access channel offset 626. The base station is typically aware of the timing of the access channel offsets.

In step 1014, the base station determines when the access channel offset is to occur. In some implementations, an access channel offset threshold 632, a predefined time prior to the offset, is determined. In step 1016, the system determines whether it is within the offset threshold period. If the system is not within the offset threshold then the process 1010 returns to step 1012. In some embodiments, the process 1010 may include optional step 1022, where an examination of the resource usage is initiated to determine if usage has a predetermined relationship with respect to a predefined usage threshold 636. This relationship depends on the system, the load, types of communications, and other factors. The relationship to the usage threshold in step 1022 allows the system to determine whether resource usage of the current reverse channel communications (e.g. dedicated channel communications) is at sufficient levels where interference may result with one or more access channel communications. In step 1022, if the resource usage is below the usage threshold 636, (i.e., generally too low to cause a level of interference with an access channel communication that would prevent accurate detection of the access channel communication) a modification and/or reallocation of reverse link resource usage is typically not necessary and the process 1010 returns to step 1012.

If it is determined in step 1022 that the resource usage is above the predefined threshold 636, then the process 1010 moves to step 1024 where a reduction in resource usage of one or more reverse channel communications is initiated. An example of step 1024, where resource usage of one or more reverse channel communications is reduced, is to reduce the dedicated channel resource usage.

In some embodiments, reducing the resource usage in step 1024 may include reducing a transmission data rate of one or more transmission sources (e.g. a dedicated channel transmission) on the reverse channel. Additionally or alternatively, reducing the resource usage may include reducing the transmit power of a transmission source on the reverse channel. Furthermore, a probability may be assigned to the reducing of the resource usage of the reverse channel communications (as described above and further described below). A probability assigned in step 1024 allows for finer control of the reverse channel communication resource usage.

Following step 1024 and the reduction of resource usage of one or more reverse channel communications at the beginning of an access slot, the process 1010 continues to step 1030 to determine whether an access channel communication is being transmitted over the access channel. If the system detects the absence of an access probe in step 1030, the process 1010 moves to step 1034 and reallocates and/or increases the resource usage of reverse channel communications. In some implementations, the base station detects the absence of the access channel communication (e.g., detecting a final CRC). Additionally or alternatively, the mobile station(s) can detect the end and/or absence of the access channel communication, for example, through use of peer-to-peer communications, compact mode third generation partnership project (3GPP) time division multimplexing (TDM) and other methods.

When the system does detect an access probe transmission in step 1030, the process 1010 continues to step 1032 where a monitoring of the resource usage occurs, allowing the system to continue to adjust resource usage depending on the load and/or when needed to limit interference between the access probe and other reverse channel communications. The process 1010 returns to step 1030 to determine if an access probe is still present. Upon detection of the absence of an access probe (e.g., the access probe communication over the access channel is complete, lost, an error is detected, it is determined that the signal quality meets a predefined relationship with respect to a quality threshold, and/or other such events), the process 1010 moves to step 1034 where an increase of the resource usage of reverse channel communications occurs, and then returns to step 1012.

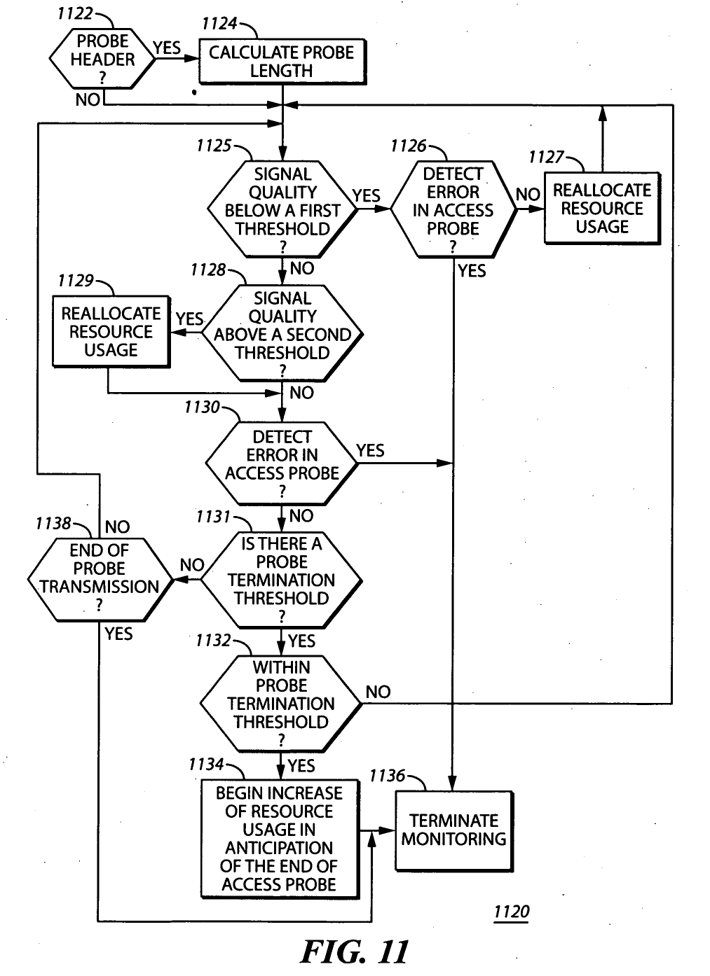

FIG. 11 depicts one example of a process 1120 for use in monitoring and adjusting resource usage. In some embodiments, the process 1120 can be utilized to implement step 1032 of FIG. 10. In step 1122, the system determines if the access channel communication (e.g., access probe) contains a message header defining a probe length or duration. If the system does not detect a probe header, the process 1120 skips to step 1125 to evaluate the quality of the access probe signal. If a probe length or duration is defined, the process continues to step 1124, where the header is decoded and the system calculates the probe length to determine when the end of the probe will occur. In one implementation, step 1124 further determines where a probe termination threshold 822 will occur.

The probe termination threshold 822, as described above, can be used in offsetting for the delay the system experiences in reacting to an initiation of a reallocation in resource usage and/or the actual adjustment made by the transmission sources. The probe termination threshold in some implementations is a time period prior to the end of the probe in which the system begins initiating an increase of resource usage of the reverse channel communications such that little or no delay occurs between the end of the access probe and an actual increase in resources. Once step 1124 is completed, and a probe termination threshold is defined, the process 1120 moves to step 1125.

In step 1125 the system compares the signal quality of the access probe to a first predefined quality threshold. The first quality threshold can be a level that the access probe signal quality is to exceed such that the system can accurately receive the access probe. If the signal quality has at least a predefined relationship with respect to this first quality threshold (e.g., the signal quality equals and/or drops below the first threshold), the system moves to step 1126 where the system may determine if there is an error in the access probe. When the system detects an error in the access probe, the process 1120 moves to step 1136 to terminate the monitoring of the access channel communication and begin increasing resource usage by other communications on the reverse channel. When an error is not detected in step 1126, the process 1120 moves to step 1127 where a further reallocation (e.g. a further decrease) of the resource usage of reverse channel communication is initiated to further reduce interference from other communications (e.g., between dedicated reverse channel communications of the same or different sectors and/or cells, other access channel communications, and/or other resource usage). Based on the further reallocation of resources provided in step 1127, the system provides for simultaneously receiving more than one access channel communication by further distributing resources as needed to those communications. The process 1120 then returns to step 1125 to monitor the signal quality of the access probe.

If it is determined in step 1125 that the access probe has a signal quality, for example, at or above the first quality threshold, the process 1120 moves to optional step 1128 where the system compares the signal quality of the access probe to a predefined second quality threshold. The second quality threshold can define a level at which the communication is accurately being received and thus the amount of resources reserved for the access channel communication(s) is generally more than is needed. Therefore, when the access probe signal quality exceeds this level, the strength of the signal allows the system to redistribute resources back to the non-access channel communications. If the signal quality has at least a predefined relationship with respect to this second quality threshold (e.g., the signal quality equals and/or exceeds the second threshold), the system moves to step 1129 where the system may reallocate a least a part of the reverse channel resources to non-access channel communications. After step 1129, the system 1120 moves to step 1130 where the system may determine if an error in the access probe has been received. In many wireless communication systems and/or protocols, when an error occurs in receiving an access probe and/or other access channel communications the entire access channel communication is to be re-transmitted during a subsequent or later access channel slot. Therefore, the process 1120 may be configured to move to step 1136 and terminate monitoring of the resource usage upon detecting an error in the access probe where step 1030 in FIG. 10 follows where an absence of the access channel communication is determined such that the process continues to step 1034 where a portion of the resource usage reserved for the access channel communication may be redistributed to one or more other reverse channel communications. This method increases efficiency in the system by at least reducing wasted capacity 924 used by an access probe that is to be re-transmitted due to detected errors (see FIG. 9).

When it is determined in step 1130 that the communication is being and/or has been accurately received (e.g., received with only minimal errors or without critical errors), the process 1120 moves to step 1131 where it is determined if there is a probe termination threshold 822 (see FIG. 8). If there is not a probe termination threshold, the process 1120 moves to step 1138 where the access probe transmission is monitored to determine when the end of the probe termination occurs. Once the end of the probe termination is detected, the process 1120 moves to step 1136 and terminates the monitoring of the resource usage.

Alternatively, if in step 1131 a probe termination threshold exists, the process 1120 moves to step 1132 to determine if the probe is within the probe termination threshold. If the probe termination threshold is not reached, process 1120 returns to step 1126 to continue to monitor signal quality. Once the probe termination threshold 822 is reached in step 1132, process 1120 moves to step 1134 to initiate an increase of the resource usage of reverse channel communication(s) in anticipation of the end of the access probe 830. Process 1120 then moves to step 1136 to terminate the monitoring process 1120 upon termination of the access probe.

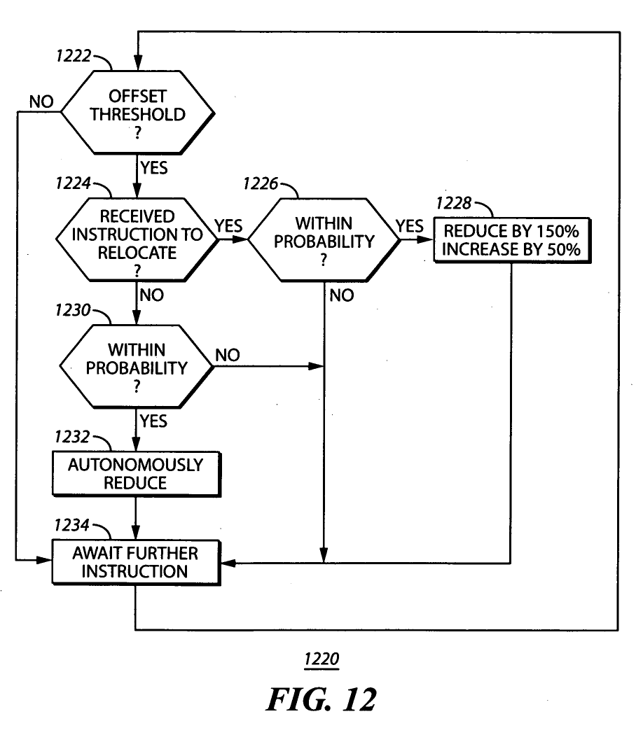

FIG. 12 depicts a simplified flow diagram of a process 1220 for use in reallocating reverse channel resources of one or more transmitting devices transmitting non-access channel communication(s) over the reverse channel. The process 1220 begins at step 1222 where a transmission source, such as a mobile station 124, determines whether it is within the access channel offset threshold 632 (see FIG. 6). When an offset threshold has not been reached, the process continues to step 1234 to await and carry out further instruction and/or returns to step 1222 to detect the offset threshold.

Alternatively, when the offset threshold has been detected, the process continues to step 1224, where the mobile station determines whether an external resource usage reallocation instruction has been received from an external source, such as a base station 122, to reallocate resources. If an instruction has been received, the process 1220 optionally continues to optional step 1226 where it is determined whether the mobile station is within a defined probability (e.g., a probability given with the instruction to reallocate). If the mobile station is within the probability, the process 1220 moves to step 1228. Alternatively, when the mobile station determines it is not within the probability, the process 1220 skips to step 1234 where the mobile station waits and carries out further instruction until the offset threshold is detected again and the process 1220 returns to step 1222 to await the detection of a subsequent offset threshold 632 while continuing to operate.

One example of an implementation of step 1228 is for the mobile station to interpret the instruction to reallocate resources the same at all times. Another example of step 1228 is for the mobile station to interpret an instruction to reallocate resources differently within the access channel offset threshold 632 than during other parts of the access channel slot 628. As such, during as access channel slot, a typical instruction bit of 1 can indicate to the mobile station to increase by a power unit of 1, and an instruction bit of 0 can indicate a decrease in power by a unit of 1. Whereas, if the mobile station determined it is within the offset threshold period, then an instruction bit of 1 is interpreted by the mobile station to increase power by less than a unit of 1 (e.g. 0.5 units, 0.25 units, or some other value less than 1), and an instruction bit of 0 is interpreted to reduce power by more than a unit of 1 (e.g. 1.50 units, 1.25 units, or some other value greater than 1). Other interpretations of the power adjustment instruction received during the offset threshold period can be implemented depending of the system, the load, and other similar factors.

In step 1224, if the mobile station has not received an instruction to reallocate resources, the process 1220 proceeds to optional step 1230 where the mobile station determines if it is within a predefined probability used to determine where the mobile station should autonomously reduce non-access channel resources. If the mobile station is not within the probability in step 1230, then the process 1220 skips to step 1234 to await and carry out further instruction.

Alternatively, if the mobile station determines in step 1034 that it is within the predefined probability, then the process 1220 proceeds to step 1232 where the mobile station autonomously reduces non-access channel resources by a predefined quantity at a time prior to the beginning of an access channel slot (e.g., initiating the reduction at the offset threshold 632). The process 1220 then proceeds to step 1234 to await and carry out further instruction of resource allocation, and returns to step 1222 where the mobile detects the access channel offset threshold again.

The present embodiments provide methods and systems the control resource usage of at least a reverse channel in attempts to optimize the use of the resources and reduce wasted resources, at least during peak or heavy loads. The reduction in wasted resources is achieved, in part, by anticipating the communication of access channel communications and allocating resources just prior to receiving access channel communications so that these communications have adequate resources to be accurately communicated. Additionally, the present embodiments detect when access channel communications have not been received, have failed to accurately be received, and/or when the access channel communication is complete, to allow for relatively rapid reallocation of the resources for other non-access channel communications.

While the invention herein disclosed has been described by means of specific embodiments and applications thereof, numerous modifications and variations could be made thereto by those skilled in the art without departing from the scope of the invention set forth in the claims.

What is claimed is:

1. A method for use in wireless communication, comprising:
determining a starting time of an access channel slot of a reverse channel;
reducing resource usage of reverse channel resources of at least one of a plurality of communications over the reverse channel prior to the starting time of the access channel slot; and
detecting an absence of an access channel communication and increasing the resource usage of at least one of the plurality of communications over the reverse channel.

2. The method of claim 1, further comprising:
determining a signal quality of the access channel communication; and
reallocating the resource usage of at least one of the plurality of communications over the reverse channel depending on the quality of the access channel communication.

3. The method of claim 1, wherein reducing the resource usage comprises initiating the reducing of the resource usage when the resource usage on the reverse channel has at least a predetermined relationship with respect to a first channel resource usage threshold.

4. The method of claim 1, wherein reducing the resource usage comprises:
defining a probability according to an amount of resource usage to reduce; and
reducing the resource usage of the at least one of the plurality of communications according to the probability.

5. The method of claim 1, wherein detecting the absence of the access channel communication comprises detecting the absence of a preamble of the access channel communication.

6. The method of claim 1, further comprising:
determining a duration of the access channel communication from one or more parameters within the access channel communication; and
the detecting the absence of the access channel communication comprises anticipating an end of the access channel communication based on the duration.

7. The method of 6, further comprising:
initiating the increasing of the resource usage of the at least one of the plurality of communications over the reverse channel prior to the end of the access channel communication.

8. The method of claim 1, wherein detecting the absence of the access channel communication comprises detecting an error in receiving the access channel communication.

9. The method of claim 1, further comprising:
detecting when a signal quality of the access channel communication has at least a predetermined relationship with respect to a first quality threshold; and
further reducing resource usage of at least one of the plurality of communications over the reverse channel.

10. The method of claim 1, wherein detecting an absence of an access channel communication comprises:
detecting when a signal quality of the access channel communication has at least a predetermined relationship with respect to a second quality threshold and halting attempts to receive the access channel communication; and
increasing the resource usage comprises reallocating freed reverse channel resources associated with the access channel communication to one or more of the plurality of communications over the reverse channel.

11. The method of claim 1, further comprising:
reducing resource usage of at least one of a plurality of communications in a neighboring reverse channel sector.

12. The method of claim 1, further comprising:
detecting when resource usage on the reverse channel has at least a predetermined relationship with respect to a second channel usage threshold and decreasing a duration of a plurality of access channel slots.

13. The method of claim 1, wherein reducing resources further comprises:
reducing transmit power of at least one of a plurality of communications over the reverse channel prior to the starting time of the access channel slot;
detecting an access channel communication; and
reducing transmission data rate of the at least one of the plurality of communications over the reverse channel upon the detection of the access channel communication.

14. A method for use in wirelessly communicating over a reverse channel, comprising:
transmitting non-access channel communication over a reverse channel;
determining an offset threshold defined by a time duration prior to a starting time of an access channel slot; and
reducing transmission resource usage of the non-access channel communication in response to an occurrence of the offset threshold.

15. The method of claim 14, wherein the reducing transmission resource usage comprises reducing transmission resource usage in response to the offset threshold occurring in the absence of receiving an external resource usage reallocation instruction.

16. The method of claim 14, further comprising:
receiving a resource usage reallocation instruction at a time within the time period threshold bound by the offset threshold instructing to adjust resource usage by a first amount; and
decreasing resource usage by a second amount that is greater than the first amount when the resource usage reallocation instruction is an instruction to decrease resource usage.

17. A wireless communication system, comprising:
a mobile station comprising:
a transmitter configured to wirelessly transmit over a reverse channel;
a reverse channel resource usage controller coupled with the transmitter and controls reverse channel resources utilized by the transmitter; and
a controller coupled with the transmitter and the resource usage controller, where the controller is configured to determine a start time for an access channel slot and an offset threshold prior to the start time, and directs the resource usage controller to control the transmitter to decrease reverse channel resources utilized by a non-access channel transmission in response to the offset threshold.

18. The system of claim 17, wherein the controller is further configured to direct the resource usage controller to reduce resource usage by a first amount upon anticipation of an offset when an external instruction is not received.

19. The system of claim 17, further comprising:
a wireless receiver that receives at least external reverse channel resource allocation instructions;
wherein the controller couples with the wireless receiver to retrieve the external resource allocation instruction such that the controller is configured to decrease the reverse channel resources utilized by the non-access channel transmission by a greater amount than instructed in the external resource allocation instruction when the external resource allocation instruction is received within a threshold period of time following the offset threshold.
